(19) United States
(12) Patent Application Publication
(10) Pub. No.: US 2013/0107961 A1
(43) Pub. Date: May 2, 2013

(54) VIDEO TRANSCODER AND VIDEO TRANSCODING METHOD

(71) Applicant: Akihiro YAMORI, Kawasaki (JP)

(72) Inventor: Akihiro YAMORI, Kawasaki (JP)

(73) Assignee: FUJITSU LIMITED, Kawasaki-shi (JP)

(21) Appl. No.: 13/601,176

(22) Filed: Aug. 31, 2012

(30) Foreign Application Priority Data
Oct. 28, 2011 (JP) 2011-237578

(51) Int. Cl. H04N 7/32

(52) U.S. Cl. 375/240.16; 375/240.12; 375/E07.243

(57) ABSTRACT

A video transcoder includes: a decoding unit which decodes coded video data in which each of blocks in a frame included in the coded video data has been coded for each first unit of coding by switching a frame coding mode and a field coding mode; a coding mode determination unit which determines a coding mode to be applied among the frame coding mode and the field coding mode, based on a first statistical value regarding the frame coded blocks and a second statistical value regarding the field coded blocks for each second unit of coding larger than the first unit of coding; and a re-coding unit which re-codes a block which belongs to a first frame and is coded with reference to a second frame, in the coding mode which is determined to be applied.

### CROSS-REFERENCE TO RELATED APPLICATION

This application is based upon and claims the benefit of priority of prior Japanese Patent Application No. 2011-237578, filed on Oct. 28, 2011, the entire contents of which are incorporated herein by reference.

### FIELD

The embodiments discussed herein are related to a video transcoder, a video transcoding method, and computer programs for transcoding video data, which decode video data coded in accordance with a first coding scheme, and after that, re-code video data again in accordance with a second coding scheme.

### BACKGROUND

Video files, or data sets, are generally large in data amount. When an apparatus dealing with the video data attempts to send the video data to another apparatus or store the video data in a storage apparatus, the apparatus compresses the video data. As a typical coding scheme of video, Moving Picture Experts Group phase2 (MPEG-2), MPEG-4, or H.264 MPEG-4 Advanced Video Coding (H.264 MPEG-4 AVC) is utilized which has been developed by the International Standardization Organization/International Electrotechnical Commission (ISO/IEC).

Since supported coding techniques are different in each of a plurality of coding schemes, coding efficiency also changes with utilized coding scheme. Therefore, there is a need to reduce the size of the video data coded in accordance with a predetermined video coding scheme.

Moreover, the calculation amounts for coding processes or decoding processes are also different between a plurality of coding schemes. Therefore, an apparatus in which a hardware resource is limited, such as a cellular phone and a personal digital assistant, may only support a coding scheme by which the calculation amount is relatively lower. In order to accommodate the video data coded by another apparatus in such an apparatus that supports only the coding scheme with relatively lower calculation amount, there is a further need to code the coded video data again in accordance with another coding scheme.

Under such circumstances, a video transcoder (also referred to as a transcoder) has been developed which decodes video data coded by any of video coding schemes before, and codes the decoded video data again in accordance with another coding scheme.

For example, in H.264 MPEG-4 AVC and MPEG-2, both of a field coding mode which performs a motion prediction in a unit of field and a frame coding mode which performs the motion prediction in a unit of frame are adopted to an interlaced image. In the field coding mode, motion vectors for performing the motion compensation are assigned separately to a top field component and a bottom field component in a macroblock. On the other hand, in the frame coding mode, a motion vector is assigned to a macroblock including both of the top field component and the bottom field component. Thus, a transcoder has been proposed which can switch between the field coding mode and the frame coding mode, when re-coding the video data, which has coded in accordance with MPEG-2, in accordance with H.264 MPEG-4 AVC (for example, refer to Japanese Laid-open Patent Publication No. 2009-212608).

### SUMMARY

The coding scheme which can switch between the field coding mode and the frame coding mode in a unit of a picture or a unit of slice is referred to as Picture Adaptive Frame Field (PAFF). On the other hand, the coding scheme which can switch between the field coding mode and the frame coding mode in a unit of macroblock pair including two macroblocks adjacent to each other in the vertical direction, as adopted by H.264 MPEG-4 AVC, is referred to as MacroBlock Adaptive Frame Field (MBAFF). According to the transcoder disclosed in Japanese Laid-open Patent Publication No. 2009-212608, with respect to the interlaced image coded before, the coding mode to be applied when re-coding is determined in the unit of macroblock pair by a combination of the coding modes of respective macroblocks included in the macroblock pair.

On the other hand, there is a need to re-code the interlaced image, which has been coded in MBAFF scheme, in accordance with PAFF coding scheme. Such a re-coding is performed in order to re-code video data by the video transcoder which has a coding device not supporting MBAFF scheme having relatively large calculation amount, due to a limited hardware resource, for example. To perform such a re-coding, the video transcoder preferably select a coding mode which has higher coding efficiency among the field coding mode and the frame coding mode, for each unit of re-coding in conformity with PAFF. This is because the prediction image generated by applying a motion compensation using a motion vector significantly differs from the macroblock if a suitable prediction procedure is not applied when re-coding, and thereby coding efficiency may decline. However, the transcoder disclosed in Japanese Laid-open Patent Publication No. 2009-212608 does not re-code the picture, which has been coded in accordance with MBAFF scheme, in accordance with PAFF scheme. Therefore, when re-coding the video data coded by MBAFF scheme in accordance with PAFF scheme, a technique is required which appropriately determines the coding mode to be applied from among the field coding mode and the frame coding mode.

According to one embodiment, a video transcoder that re-codes each of a plurality of blocks divided from a frame included in a coded video data which has been coded for each first unit of coding by switching a frame coding mode for coding the blocks on the basis of a frame and a field coding mode for coding the blocks on the basis of a field, in any of the frame coding mode and the field coding mode for each second unit of coding, is provided. The video transcoder includes: a decoding unit which decodes the coded video data; a coding mode determination unit which calculates a first statistical value regarding the number of frame coded blocks or a degree of motion of an object shown in the frame coded blocks, and a second statistical value regarding the number of field coded blocks or a degree of motion of the object shown in the field coded blocks for each second unit of coding of the coded video data, and compares the first statistical value and the second statistical value to determine a coding mode to be applied among the frame coding mode and the field coding mode for each second unit of coding; and a re-coding unit which re-codes a block which belongs to a first frame and is coded with reference to a second frame, which is different from the first frame, among a plurality of blocks within the second unit of coding, in the coding mode which is determined to be applied among the frame coding mode and the field coding mode, for each second unit of coding. In addition, the second unit of coding is larger than the first unit of coding.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic configuration diagram of a video transcoder according to a first embodiment.

FIG. 2 is an exemplary diagram of a frame when applying a frame-coding or a field coding to an interlace image in accordance with MBAFF manner.

FIG. 3 is an exemplary diagram of a frame when applying a frame coding or a field coding to an interlaced image in accordance with PAFF manner.

FIG. 4 is a drawing illustrating an example of a frame.

FIG. 5 is an operational flowchart of a video transcoding process according to the first embodiment.

FIG. 6 is a schematic configuration diagram of a video transcoder according to a second embodiment.

FIG. 7 is an operational flowchart of a video transcoding process according to the second embodiment.

FIG. 8 is a schematic configuration diagram of a video transcoder according to a third embodiment.

FIG. 9 is an operational flowchart of a video transcoding process according to the third embodiment.

FIG. 10 is a schematic diagram of a computer capable of executing the video transcoding process according to any of embodiments or modifications.

### DESCRIPTION OF EMBODIMENTS

Hereinafter, a video transcoder according to various embodiments will be explained with reference to drawings. The video transcoder re-codes video data, which has been frame-coded or field-coded in a unit of macroblock pair (a first unit of coding), in a unit of re-coding (a second unit of coding) which complies with PAFF scheme while switching the frame coding or the field coding. In this case, the video transcoder calculates a statistical value regarding the number of macroblocks or a degree of motion of an object on the macroblocks, with respect to each of the field coded macroblocks and the frame coded macroblocks in the unit of re-coding. The video transcoder determines a coding mode to be applied in the re-coding, based on comparison result between the statistical value regarding the macroblock coded in accordance with a field coding mode and statistical value regarding the macroblock coded in accordance with a frame coding mode.

The video data in each embodiment described later is an interlaced image which alternately includes a top field including only the data of odd-numbered row in a frame and a bottom field including only data of even-numbered row therein. Moreover, in this specification, the term “picture” refers to a case where it can be any of the frame or the field.

First, the video transcoder according to a first embodiment will be described. The video transcoder calculates, with respect to the video data coded in accordance with MBAFF scheme, the number of the field coded macroblocks which are coded in accordance with the field coding mode as the statistical value regarding the field coded macroblocks, in the unit of re-coding. Similarly, the video transcoder calculates the number of the frame coded macroblocks which are coded in accordance with the frame coding mode as the statistical value regarding the frame coded macroblocks.

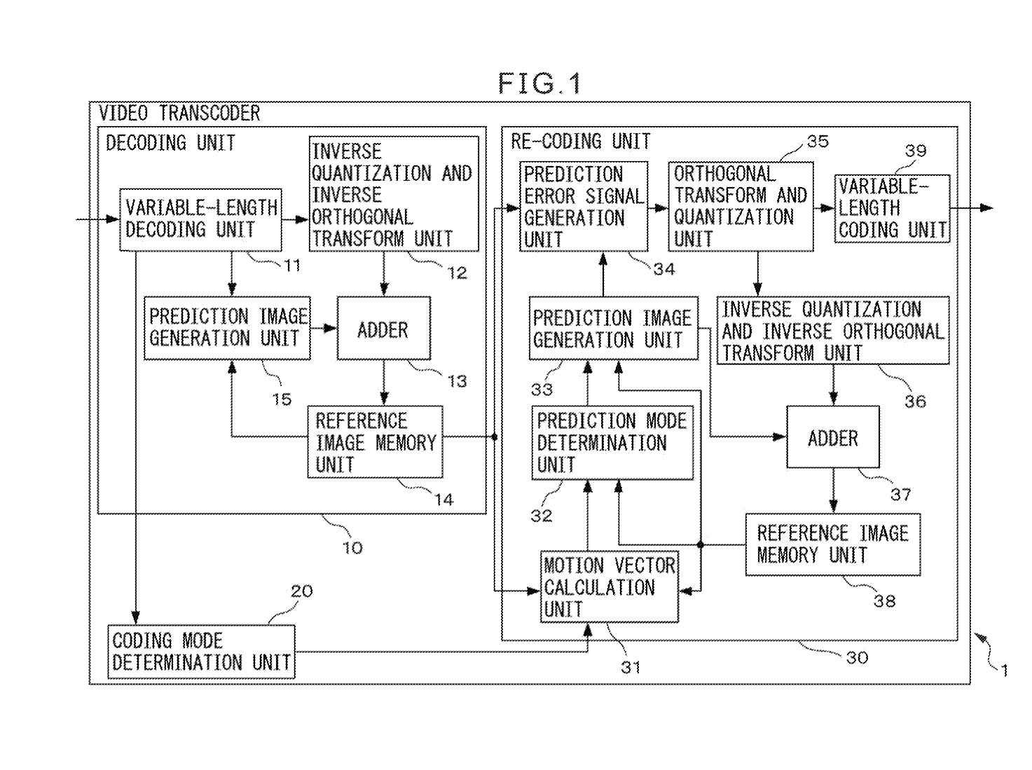

FIG. 1 is a schematic configuration diagram of the video transcoder according to the first embodiment. The video transcoder 1 includes a decoding unit 10, a coding mode determination unit 20, and a re-coding unit 30. Each of these units included in the video transcoder 1 can be formed as separated circuits. Alternatively, each of these units included in the video transcoder 1 may be implemented in the video transcoder 1 as an integrated circuit on which circuits corresponding to those respective units are integrated. Furthermore, each of these units included in the video transcoder 1 may be a functional module realized by a computer program executed on a processor included in the video transcoder 1.

The video transcoder 1 may, for example, acquire a data stream including the coded video data through a communication network and an interface circuit which is for connecting the video transcoder 1 to the communication network. The video transcoder 1 makes a buffer memory (which is not illustrated) to store the data stream. The video transcoder 1 reads the coded video data from the buffer memory in accordance with an order of the coded picture, and inputs the picture into the decoding unit 10. The decoding unit 10 decodes the coded picture and transfers the decoded picture to the re-coding unit 30. Moreover, the decoding unit 10 transfers information as to whether the field coding is performed or the frame coding is performed, in the unit of macroblock, to the coding mode determination unit 20. The macroblock may have a size of 16×16 pixels, for example. However, the size of macroblock may be larger or may be smaller than the size of 16×16 pixels.

The coding mode determination unit 20 selects the coding mode to be applied when performing the re-coding from among the frame coding mode and the field coding mode, for every unit of re-coding in conformity with PAFF scheme.

The re-coding unit 30 re-codes the decoded picture. In this embodiment, the re-coding unit 30 re-codes each macroblock to be inter-coded in accordance with the determined coding mode to be applied for the macroblock.

Hereinafter, each unit of the video transcoder 1 will be described in detail.

The decoding unit 10 includes a variable-length decoding unit 11, an inverse quantization and inverse orthogonal transform unit 12, an adder 13, a reference image memory unit 14, and a prediction image generation unit 15.

The variable-length decoding unit 11 performs a variable-length decoding for the video data, which has been coded by the variable-length coding in the unit of macroblock. The variable-length coding scheme may be, for example, Huffman coding scheme such as Context-based Adaptive Variable Length Coding (CAVLC), or arithmetic coding scheme such as Context-based Adaptive Binary Arithmetic Coding (CABAC). The variable-length decoding unit 11 reproduces quantized signal which is a quantized prediction error signal. Moreover, if a subject macroblock has been inter-coded, the variable-length decoding unit 11 decodes a motion vector about the macroblock by the variable-length decoding. The inter-coding is a coding scheme which codes the subject picture utilizing correlativity between the subject picture and the pictures before or after the subject picture. Then, the variable-length decoding unit 11 transfers the reproduced motion vector to the prediction image generation unit 15. Moreover, the variable-length decoding unit 11 transfers the quantized signal to the inverse quantization and inverse orthogonal transform unit 12.

Furthermore, the variable-length decoding unit 11 extracts various kinds of information required for decoding, such as information representing a prediction mode applied to the macroblock which is coded by intra prediction coding or inter prediction coding and so on, from header information included in the coded video data. Then, the variable-length decoding unit 11 notifies the prediction image generation unit 15 of the prediction mode.

At that time, the variable-length decoding unit 11 acquires coding mode information that represents whether the frame coding is applied or the field coding is applied for every macroblock pair. When input video data is coded by MBAFF scheme in accordance with H.264 MPEG-4 AVC, the variable-length decoding unit 11 refers to a flag mbFieldDecodingFlag which is included in a slice syntax specified for every slice and specified for every macroblock pair, as the coding mode information. Thus, the variable-length decoding unit 11 can specify the coding mode of the macroblock pair. If mbFieldDecodingFlag is “1”, corresponding field coded macroblock pair. On the other hand, if mbFieldDecodingFlag is “0”, corresponding frame coded macroblock pair.

In some embodiments, mbFieldDecodingFlag of the subject macroblock pair may be omitted. In this case, if the subject macroblock pair is in the identical slice as an adjacent macroblock pair on left side or on top side, the variable-length decoding unit 11 determines that the subject macroblock pair has been coded by the identical coding mode as the adjacent macroblock pair. If a slice to which the subject macroblock pair belongs is different from a slice to which the adjacent macroblock on left side or on top side belongs, the variable-length decoding unit 11 determines that the subject macroblock pair has been coded in the frame coding mode.

When the input video data is coded in accordance with MPEG-2, the variable-length decoding unit 11 refers to three kinds of flags frameMotionType, fieldMotionType, or dctType as the coding mode information, and whereby, can specify the coding mode. For example, the variable-length decoding unit 11 determines that the macroblock to which fieldMotionType is specified has been field-coded. The variable-length decoding unit 11 determines that the macroblock corresponding to the frameMotionType has been frame-coded, if a code value of frameMotionType is “10”. On the other hand, the variable-length decoding unit 11 determines that the macroblock corresponding to the frameMotionType has been field-coded if the code value of frameMotionType is another value. Furthermore, the variable-length decoding unit 11 determines that the macroblock corresponding to the dctType has been field-coded, if a value of dctType is “1”, and determines that the macroblock corresponding to the dctType has been frame-coded, if a value of dctType is “0”.

The variable-length decoding unit 11 outputs a flag representing whether the frame coding is applied or the field coding is applied, to the coding mode determination unit 20 for every macroblock pair. Furthermore, when the variable-length decoding unit 11 extracts a slice header and a picture header which indicate a delimiter between the units of re-coding, the variable-length decoding unit 11 may notify the coding mode determination unit 20 that the delimiter is detected between the units of re-coding.

The inverse quantization and inverse orthogonal transform unit 12 multiplies a quantized signal received from the variable-length decoding unit 11 by a certain number corresponding to a quantization width determined by a quantization parameter acquired from the header information included in the coded video data, to perform the inverse quantization. This inverse quantization reproduces the frequency signal of the macroblock. The frequency signal is, for example, a group of coefficients representing intensities for respective frequency components, which is obtained by the orthogonal transform process, and the orthogonal transform process is applied to the macroblock by the video coding apparatus which coded the input video data. For example, when the discrete cosine transform (DCT) is used as the orthogonal transform process, the group of DCT coefficients is obtained by performing the inverse quantization for the quantized signal. On the other hand, when the Hadamard transform is used as the orthogonal transform process, the group of Hadamard coefficients is reproduced by performing the inverse quantization for the quantized signal. After that, the inverse quantization and inverse orthogonal transform unit 12 performs the inverse orthogonal transform for the frequency signal. This inverse orthogonal transform process is an inverse transform of the orthogonal transform process applied to the macroblock. By performing the inverse quantization and the inverse orthogonal transform for the quantized signal, the prediction error signal is reproduced. The inverse quantization and inverse orthogonal transform unit 12 outputs the prediction error signal reproduced for every macroblock to the adder 13.

The adder 13 adds, to each pixel value of the prediction image received from the prediction image generation unit 16, the reproduced prediction error signal corresponding to the pixel, for every macroblock, to reproduce the macroblock. Then, the adder 13 reproduces the picture by combining the reproduced macroblocks in accordance with a coding order. The adder 13 makes the reference image memory unit 14 store the reproduced picture.

In some embodiments, the reference image memory unit 14 includes a frame memory. The reference image memory unit 14 stores temporarily the picture received from the adder 13. The reference image memory unit 14 supplies the picture to the prediction image generation unit 15 as a reference image. Moreover, in some embodiments, each picture stored in the reference image memory unit 14 is rearranged in time order, and after that, each picture is read and output to the re-coding unit 30. If it is acceptable that a coding order of pictures for the input video data is the same as a coding order of pictures for the re-coding, the decoding unit 10 may output each picture in accordance with the reproduction order.

The reference image memory unit 14 stores the predetermined number of pictures, and deletes sequentially from a picture with old coding order, when the volume of stored data exceeds the amount corresponding to the predetermined number of pictures.

The prediction image generation unit 15 generates the prediction image in accordance with the prediction mode extracted from header information, for every macroblock which is coded by the prediction coding.

The prediction image generation unit 15 reads the reference image used when coding the subject macroblock from the reference image memory unit 14. If the applied prediction mode is any prediction mode for the inter coding such as forward prediction mode or backward prediction mode, the prediction image generation unit 15 generates the prediction image by performing the motion compensation using the motion vector for the reference image. The motion vector represents a spatial moving amount between the subject macroblock and the reference image which is most similar to the macroblock. The motion compensation is a process which moves the position of the block on the reference image which is most similar to the macroblock, so that the shift amount of position between the macroblock and the block on the reference image which is most similar thereto, may be canceled.

If the subject macroblock has been frame-coded, the prediction image generation unit 15 performs, for the reference image, the motion compensation using the motion vector obtained for the macroblock which is set on the frame. On the other hand, if the subject macroblock has been field-coded, the prediction image generation unit 15 performs the motion compensation for the reference image for every field, using the motion vector obtained for the top field and the motion vector obtained for the bottom field respectively.

Moreover, if the applied prediction mode is a prediction mode for the intra coding in which the macroblock in the picture which has been coded is referred, the prediction image generation unit 15 generates the prediction image from the reference image in accordance with the applied prediction mode among the intra coding mode.

The prediction image generation unit 15 transfers the generated prediction image to the adder 13.

The coding mode determination unit 20 selects a coding mode to be applied to the macroblock in unit of re-coding which complies with PAFF scheme at the time of re-coding, from among the frame coding mode and the field coding mode. The unit of re-coding can be a unit of slice obtained by dividing a frame into a plurality of slices, a unit of frame, or a unit of GroupOfPictures (GOP), for example. Each slice is set so that the slice includes a plurality of macroblocks. For example, the frame is divided into a slice including the upper half of the frame and a slice including the lower half of the frame. Alternatively, the unit of re-coding can be a unit of reorder corresponding to a group of frames which is replaced in order when applying the inter coding.

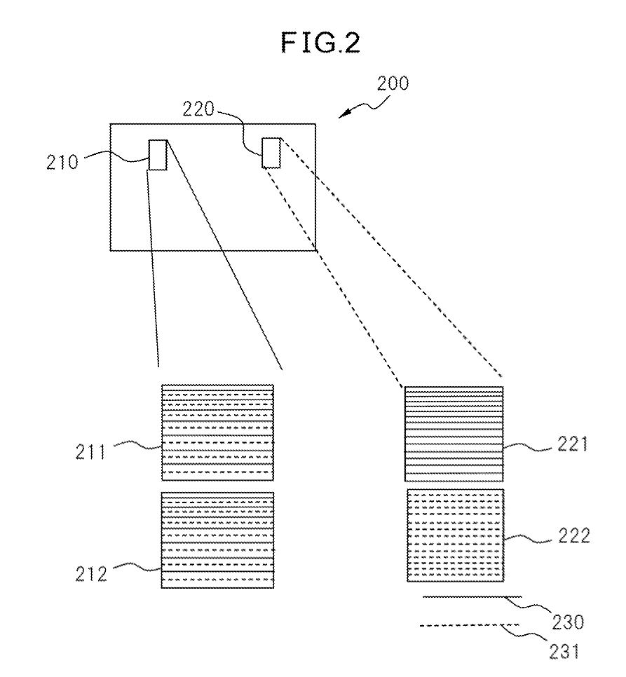

FIG. 2 is an exemplary diagram of a frame when the interlace image is frame-coded or field-coded in accordance with MBAFF manner. In the frame 200, a macroblock pair 210 is an example of the frame coded macroblock pair, and on the other hand, a macroblock pair 220 is an example of the field coded macroblock pair.

The frame coded macroblock pair 210 includes two macroblocks 211 and 212 of 16×16 pixels, in which top field components 230 and bottom field components 231 are included alternately in vertical direction, and respective macroblocks are separately motion-compensated.

On the other hand, the field coded macroblock pair 220 includes a macroblock 221 including only top field components of 16×16 pixels and a macroblock 222 including only bottom field components of 16×16 pixels. The macroblocks 221 and 222 are separately motion-compensated.

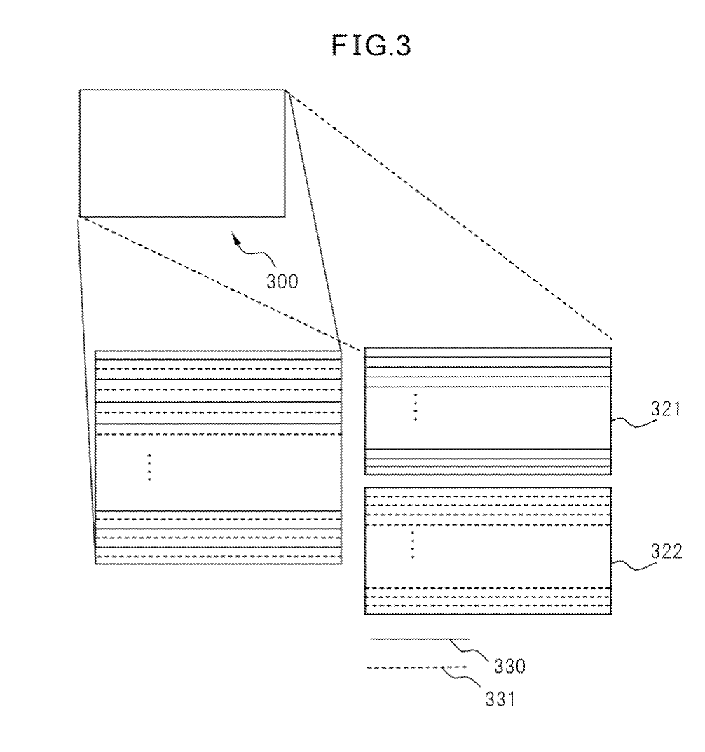

FIG. 3 is an exemplary diagram of a frame when an interlaced image is frame-coded or field-coded in accordance with PAFF manner. When the frame 300 is frame-coded, the frame 300 includes top field components 330 and bottom field components 331 alternately in vertical direction throughout the frame. Then, the motion compensation is applied for every macroblock with the size of 16×16 pixels, which is set on the frame 300.

On the other hand, when the frame 300 is field-coded, the frame 300 is divided into the top field 321 including only the top field components 330 and the bottom field 321 including only the bottom field components 331. Each number of pixels of the top field 321 and the bottom field 322 are half of the number of pixels of the frame 300 in vertical direction. The macroblocks with the size of 16×16 pixels are set on the top field 321 and the bottom field 322 respectively, and each macroblock is motion-compensated.

In the coded video data, with respect to a frame in which the number of macroblocks coded in the frame coding mode is greater than the number of the macroblocks coded in the field coding mode, it is assumed that the frame coding mode has higher coding efficiency than the field coding. On the contrary, with respect to a frame in which the number of macroblocks coded in the field coding mode is greater than the number of the macroblocks coded in the frame coding mode, it is estimated that the field coding mode has higher coding efficiency than the frame coding. This is because it can be estimated that a coding mode which has higher coding efficiency is selected from among the frame coding mode and the field coding mode in order to reduce the data amount of the coded video data as much as possible when coding the video data.

In some frames, even though coding efficiency improves by applying the field coding rather than applying the frame coding to entire frame, the number of the frame coded macroblocks may be greater than the number of the field coded macroblocks in MBAFF scheme.

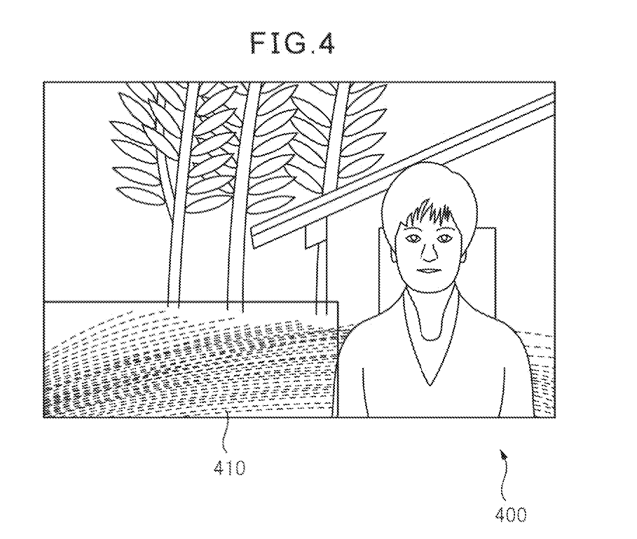

FIG. 4 is a drawing illustrating an example of the frame. For example, a plurality of water streams from a shower are shown in a local area 410 in the frame 400 as moving objects respectively. On the other hand, objects shown in area other than the area 410 substantially remain still. In such a frame, the number of the frame coded macroblocks would be greater than the number of the field coded macroblocks. This is because, with respect to the macroblock in the area in which the stationary object is shown, performing the motion compensation for the macroblock using one motion vector can decrease sufficiently the prediction error.

However, in the macroblock in which the moving object is shown as the macroblock in the area 410, the motion vectors which can minimize the prediction error may be different in the bottom field and the top field for the interlaced image. For such a macroblock, applying the field coding mode improves the coding efficiency rather than the frame coding mode. Therefore, the generated information amount when the field coding mode is applied to the macroblock in which the moving object is shown may be significantly smaller than the generated information amount when the frame coding mode is applied. As a result, with respect to a frame in which the moving object is included in the local area and the objects shown in other areas are remain still as the frame 400, applying the field coding mode may generate less information as a whole rather than applying the frame coding mode.

Therefore, the coding mode determination unit 20 counts the number of the field coded macroblocks and the number of the frame coded macroblocks respectively for every unit of re-coding. When the number of the macroblocks which are inter-coded within the unit of re-coding is notified, the coding mode determination unit 20 may count either the number of the frame coded macroblocks or the number of the field coded macroblocks.

The coding mode determination unit 20 calculate a ratio (FieldNum/Total) of the number of the field coded macroblocks (FieldNum) to a sum of the number of the frame coded macroblocks and the number of the field coded macroblocks (Total), for every unit of re-coding. The coding mode determination unit 20 determines that the field coding mode is to be applied to the unit of re-coding, if the ratio (FieldNum/Total) is equal to or more than a predetermined threshold value Th1. On the other hand, the coding mode determination unit 20 determines that the frame coding mode is to be applied to the unit of re-coding, if the ratio (FieldNum/Total) is less than the threshold value Th1. The threshold value Th1 is set so that the field coding may easily applied rather than the frame coding when re-coding, and may be set any value from 0.3 to 0.5, for example.

The coding mode determination unit 20 notifies the re-coding unit 30 of the coding mode to be applied among the frame coding mode and the field coding modes for every unit of re-coding.

The re-coding unit 30 re-codes the decoded video data in accordance with PAFF scheme. For that purpose, the re-coding unit 30 includes a motion vector calculation unit 31, a prediction mode determination unit 32, a prediction image generation unit 33, a prediction error signal generation unit 34, an orthogonal transform and quantization unit 35, an inverse quantization and inverse orthogonal transform unit 36, an adder 37, a reference image memory unit 38, and a variable-length coding unit 39.

The motion vector calculation unit 31 calculates a motion vector using the input macroblock and reference image in order to generate the prediction image for the inter coding.

When it is notified that the frame coding mode is to be applied from the coding mode determination unit 20, the motion vector calculation unit 31 calculates a motion vector for every macroblock generated from the frame. On the other hand, when it is notified that the field coding mode is to be applied from the coding mode determination unit 20, the motion vector calculation unit 31 calculates a motion vector for every macroblock generated from the top field and for every macroblock generated from the bottom field.

The motion vector calculation unit 31 performs a block matching with the input macroblock and the reference image to determine the reference image which most matches with the input macroblock and a position of the block on the picture which includes the reference image. Then, the motion vector calculation unit 31 obtains the motion vector, elements of the vector being the position of the input macroblock on the picture, moving amount in horizontal direction and in vertical direction from the reference image which most matched with the macroblock, and identification information representing the picture to which the reference image belongs.

The motion vector calculation unit 31 may divide the macroblock into a plurality of blocks, and may calculate the motion vector for each of the blocks. For example, the motion vector calculation unit 31 may divide the macroblock with 16×16 pixels into four blocks with 8×8 pixels, and may calculate the motion vectors for respective blocks.

The motion vector calculation unit 31 transfers the calculated motion vector to the prediction mode determination unit 32, the prediction image generation unit 33, and the variable-length coding unit 39.

The prediction mode determination unit 32 determines the prediction mode which specifies a generation method of the prediction image to the input macroblock. For example, the prediction mode determination unit 32 determines the prediction mode for the macroblock based on the information which represents a type of the picture to be coded including the macroblock and is acquired from the decoding unit 10. If the type of the picture to be coded is I picture, the prediction mode determination unit 32 selects the intra coding mode as the prediction mode to be applied.

Moreover, if the type of the picture to be coded is P picture, the prediction mode determination unit 32 selects, for example, either the inter coding mode or the intra coding mode as the prediction mode to be applied. It is determined whether the forward prediction mode which refers to a future picture in time is used or the backward prediction mode which refers to a past picture in time is used as the inter coding mode based on the information representing the position of the picture to be coded in GOP.

Furthermore, if the type of the picture to be coded is B picture, the prediction mode determination unit 32 selects the prediction mode to be applied from among the intra coding mode, the forward prediction mode, the backward prediction mode, and a bidirectional prediction mode.

In order to select one prediction mode from a plurality of prediction modes, the prediction mode determination unit 32 calculates costs which are evaluation values of the amount of data for the macroblocks in each prediction mode, respectively. Then, the prediction mode determination unit 32 selects a prediction mode which has the minimum cost as the prediction mode to be applied to the input macroblock.

The cost to each prediction mode is calculated as follows, for example.

$$costf = {\sum }_{i , j} \vert {org}_{i , j} - {ref}_{i , j} \vert + λ * ( Table [ mv 1 - premv 1 ] ) \\ costb = {\sum }_{i , j} \vert {org}_{i , j} - {ref}_{i , j} \vert + λ * ( Table [ mv 1 - premv 1 ] ) \\ costbi = {\sum }_{i , j} \vert {org}_{i , j} - {ref}_{i , j} \vert + λ * ( \begin{matrix}Table [ mv 1 - premv 1 ] + \\ Table [ mv 2 - premv 2 ]\end{matrix} ) \\ costi = {\sum }_{i , j} \vert {org}_{i , j} - AveMB \vert \qquad ( 1 )$$

where, costf, costb, costbi and costi are costs corresponding to the forward prediction mode, the backward prediction mode, the bidirectional prediction mode and the intra coding mode, respectively. Org_{i,j} represents a value of a pixel which has a horizontal coordinate i and a vertical coordinate j included in the input macroblock. Moreover, ref_{i,j} represents a value of a pixel which has a horizontal coordinate i and a vertical coordinate j included in the prediction image. In addition, the prediction mode determination unit 32 generates the prediction image from the reference image by the same manner as that used in the prediction image generation unit 33. Moreover, mv1 and mv2 represent the motion vectors to the input macroblock, and premv1 and Premv2 represent the motion vectors of the macroblock coded just before. Furthermore, Table [a, b] outputs estimated code amount corresponding to the difference vector between the vector a and the vector b. For example, Table [a, b] may be a reference table representing the estimated code amount to various difference vectors. Moreover, λ is a weight constant, and for example, is set as 1. AveMB is an average value of the pixel values included in the input macroblock. Moreover, regarding the motion prediction, when the direct mode can be applied which predicts the motion vector of the macroblock in the subject picture from the motion vectors of forward and backward pictures, the prediction mode determination unit 32 may also calculate a cost for the direct mode.

As described above, the macroblock may be divided into a plurality of blocks, and the motion vectors may be obtained for each of the blocks. In this case, regarding the forward prediction mode, the backward prediction mode, and the bidirectional prediction mode, the prediction mode determination unit 32 calculates the equation (1) for each block, and makes total of the costs obtained for each block the cost for the mode.

The prediction mode determination unit 32 calculates the costs with respect to respective prediction modes used as candidates for selection in accordance with equation (1). Then, the prediction mode determination unit 32 selects the prediction mode with minimum cost as the prediction mode to be applied to the input macroblock.

The prediction mode determination unit 32 notifies the prediction image generation unit 33 of the selected prediction mode.

The prediction image generation unit 33 generates the prediction image in accordance with the prediction mode selected by the prediction mode determination unit 32. When the input macroblock is inter-coded in the forward prediction mode and the backward prediction mode, the prediction image generation unit 33 performs the motion compensation for the reference image obtained from the reference image memory unit 38 based on the motion vector provided from the motion vector calculation unit 31. Then, the prediction image generation unit 33 generates the prediction image for the inter coding of the unit of macroblock, to which the motion compensation is applied.

When the macroblock is coded in the frame coding mode, the reference image is generated from the frame, and on the other hand, when the macroblock is coded in the field coding mode, the reference image is generated from the top field or the bottom field.

Moreover, when the input macroblock is inter-coded in the bidirectional prediction mode, the prediction image generation unit 33 performs the motion compensation for the reference images specified by two motion vectors respectively using the corresponding motion vectors. Then, the prediction image generation unit 33 generates the prediction image by averaging pixel values between corresponding pixels in two compensation images obtained by the motion compensation.

When the input macroblock is intra-coded, the prediction image generation unit 33 generates the prediction image from the macroblock adjacent to the input macroblock. In that case, for example, the prediction image generation unit 33 generates the prediction image in accordance with the horizontal mode, DC mode, the plain mode and so on specified in H.264 MPEG-4 AVC.

The prediction image generation unit 33 transfers the generated prediction image to the prediction error signal generation unit 34.

The prediction error signal generation unit 34 performs difference calculation between the input macroblock and the prediction image generated by the prediction image generation unit 33. The prediction error signal generation unit 34 makes the difference value corresponding to each pixel in the macroblock, obtained by the difference calculation, a prediction error signal. When the frame coding mode is applied, each macroblock is obtained by dividing the frame. On the other hand, when the field coding mode is applied, each macroblock is obtained by dividing the top field or the bottom field. Therefore, prediction error signals are generated for each of the top field and the bottom field in this case.

The prediction error signal generation unit 34 transfers the prediction error signal(s) to the orthogonal transform and quantization unit 35.

The orthogonal transform and quantization unit 35 performs the orthogonal transform for the prediction error signal for the input macroblock to calculate a frequency signal representing a frequency component of the prediction error signal in the horizontal direction and a frequency component thereof in the vertical frequency component. For example, the orthogonal transform and quantization unit 35 performs DCT as the orthogonal transform for the prediction error signal to obtain the group of DCT coefficients for every macroblock as the frequency signal. Alternatively, the orthogonal transform and quantization unit 35 may perform Hadamard transform as the orthogonal transform for the prediction error signal to obtain the group of Hadamard coefficients for every macroblock as the frequency signal.

Next, the orthogonal transform and quantization unit 35 quantizes the frequency signal. This quantization process is a process for expressing the signal values within a fixed interval by one signal value. The fixed interval is referred to herein as quantization width. For example, the orthogonal transform and quantization unit 35 quantizes the frequency signal by cutting off a predetermined number of lower bits of the frequency signal corresponding to the quantization width. The quantization width is determined by a quantization parameter. For example, the orthogonal transform and quantization unit 35 determines the quantization width to be used in accordance with a function representing a value of the quantization width to the value of the quantization parameter. The function can be a monotonically increasing function to the value of the quantization parameter, and the function is set in advance.

Alternatively, two or more quantization matrices specifying quantization widths which correspond to frequency components in horizontal direction and in vertical direction respectively are prepared beforehand, and are stored in a memory included in the orthogonal transform and quantization unit 35. Then, the orthogonal transform and quantization unit 35 selects a specific quantization matrix among those quantization matrices in accordance with the quantization parameter. The orthogonal transform and quantization unit 35 may determine the quantization width to each frequency component of the frequency signal with reference to the selected quantization matrix.

Moreover, the orthogonal transform and quantization unit 35 may determine the quantization parameter in accordance with any of the various quantization parameter determination manners corresponding to video coding standards, such as MPEG-2, MPEG-4, and H.264 MPEG-4 AVC. The orthogonal transform and quantization unit 35, for example, can use a calculation manner of the quantization parameter in the standard test model 5 of MPEG-2. As to the calculation manner of the quantization parameter in the standard test model 5 of MPEG-2, refer to, for example, the URL specified by http://www.mpeg.org/MPEG/MSSG/tm5/Ch10/Ch10.html.

The orthogonal transform and quantization unit 35 can reduce the number of bits used for expressing each frequency component of the frequency signal by performing the quantization process, and therefore, can reduce the information amount included in the input macroblock. The orthogonal transform and quantization unit 35 provides the quantization signal to the variable-length coding unit 39 and the inverse quantization and inverse orthogonal transform unit 36.

The inverse quantization and inverse orthogonal transform unit 36 and the adder 37 reproduce the macroblock coded before to generate the reference image to which is referred, for coding the following macroblock in the picture or the following picture of the picture including the macroblock.

Accordingly, the inverse quantization and inverse orthogonal transform unit 36 performs the inverse quantization by multiplying the quantization signal received from the orthogonal transform and quantization unit 35 by the predetermined number corresponding to the quantization width determined by the quantization parameter. This inverse quantization reproduces the frequency signal of the input macroblock, for example, a group of DCT coefficients. Subsequently, the inverse quantization and inverse orthogonal transform unit 36 performs the inverse orthogonal transform for the frequency signal. For example, when the DCT process is performed in the orthogonal transform and quantization unit 35, the inverse quantization and inverse orthogonal transform unit 36 performs an inverse DCT for an inverse quantization signal. The quantization signal to the inverse quantization process and the inverse orthogonal transform process reproduces the prediction error signal which includes information comparable as the prediction error signal before coding. Then, the inverse quantization and inverse orthogonal transform unit 36 outputs the prediction error signal for every reproduced macroblock to the adder 37.

The adder 37 adds the reproduced prediction error signal corresponding to the pixel to each pixel value of the prediction image for every macroblock, and reproduces the macroblocks.

The adder 37 combines the reproduced macroblocks in accordance with a coding order to generate the reference image. The adder 37 makes the reference image memory unit 38 store the reference image.

In some embodiments, the reference image memory unit 38 includes a frame memory. The reference image memory unit 38 temporarily stores the reference image received from the adder 37. Then, the reference image memory unit 38 provides the reference image to the motion vector calculation unit 31, the prediction mode determination unit 32 and the prediction image generation unit 33. The reference image memory unit 38 stores the predetermined number of reference images, and when the number of reference images exceeds a predetermined number, the reference image memory unit 38 deletes reference images in order from images of which the coding order is older.

The variable-length coding unit 39 encodes the quantized frequency signal received from the orthogonal transform and quantization unit 35 and the motion vector received from the motion vector calculation unit 31 by the variable-length coding, to generate the coding signal in which the data amount is compressed. For that purpose, the variable-length coding unit 39 can use, for example, the Huffman coding process such as CAVLC or the arithmetic coding process such as CABAC to the quantized frequency signal.

The video transcoder 1 adds predetermined information including the prediction mode for each macroblock or the like as header information to the coding signal generated by the variable-length coding unit 39, to generate a data stream including the coded video data. The video transcoder 1 stores the data stream to a memory unit (not illustrated) which includes a magnetic recording medium, an optical recording medium or a semiconductor memory, or outputs the data stream to other device(s).

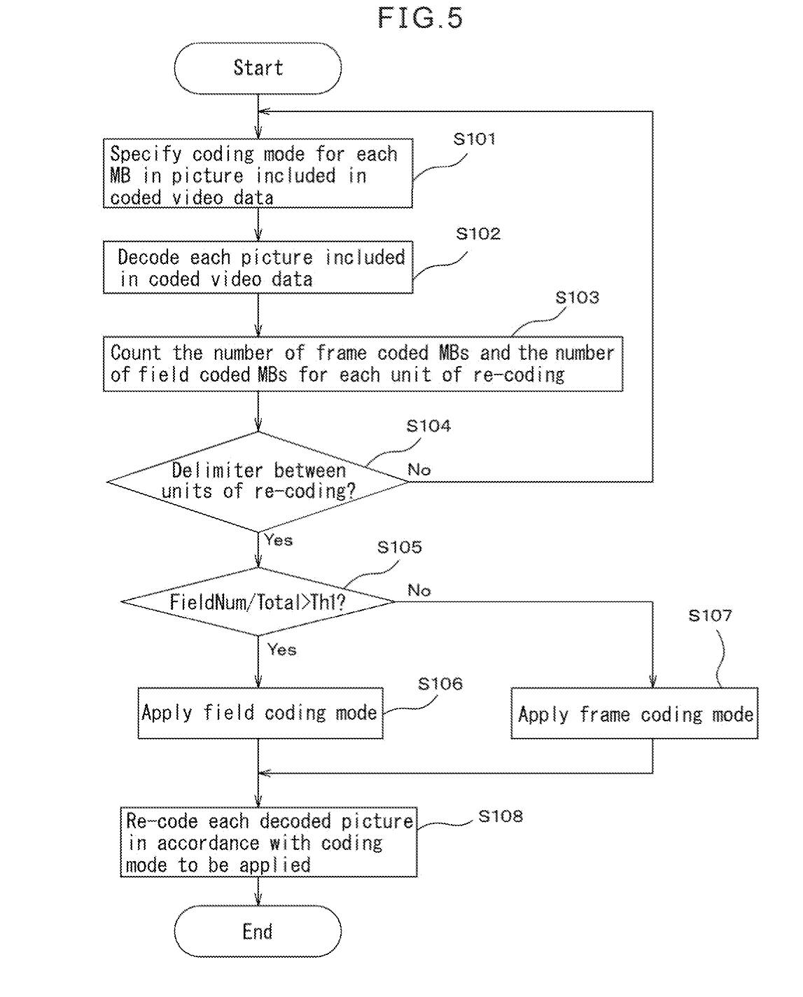

FIG. 5 is an operational flowchart of the video transcoding process performed by the video transcoder 1 according to the first embodiment. The video transcoder 1 performs the video transcoding process for every unit of re-coding.

The decoding unit 10 specifies the coding mode of each macroblock with reference to a flag, which represents the coding mode and can be extracted by performing the variable-length decoding for each macroblock in the picture included in the coded video data (step S101). Then, the decoding unit 10 notifies the coding mode determination unit 20 of information representing the coding mode of each macroblock. The decoding unit 10 decodes each picture included in the coded video data (step S102). Then, the decoding unit 10 outputs each decoded picture to the re-coding unit 30.

The coding mode determination unit 20 counts the number of the frame coded macroblocks and the number of the field coded macroblocks for every unit of re-coding (step S103). The coding mode determination unit 20 determines whether or not the notification of the delimiter between the units of re-coding has been received from the decoding unit 10 (step S104). For example, if the unit of re-coding is GOP unit, the coding mode determination unit 20 receives the notification of the delimiter between the units of re-coding each time the decoding unit 10 decodes I picture. If the unit of re-coding is a frame unit or a slice unit, each time the decoding unit 10 extracts the header information of the frame or the slice from the coded video data, the coding mode determination unit 20 receives the notification of the delimiter between the units of re-coding. Furthermore, if the unit of re-coding is a reorder unit, the coding mode determination unit 20 receives the notification of the delimiter between the units of re-coding each time the decoding unit 10 decodes I picture or P picture.

If the coding mode determination unit 20 has not received the notification of the delimiter between the units of re-coding (step S104—No), the video transcoder 1 repeats the processes from the step S101. On the other hand, if the coding mode determination unit 20 has received the notification of the delimiter between the units of re-coding (step S104—Yes), the coding mode determination unit 20 calculates the total number (Total) of the inter-coded macroblocks. Then, the coding mode determination unit 20 determines whether a ratio (FieldNum/Total) of the number FieldNum of the field coded macroblocks to the total number (Total) of the inter-coded macroblocks is equal to or more than a predetermined threshold value Th1 (step S105).

If the ratio (FieldNum/Total) is equal to or more than threshold value Th1 (step S105—Yes), the coding mode determination unit 20 determines that the coding mode to be applied to the unit of re-coding is the field coding mode, and notifies the re-coding unit 30 of the determination (step S106). On the other hand, if the ratio (FieldNum/Total) is less than the threshold value Th1 (step S105—No), the coding mode determination unit 20 determines that the coding mode to be applied to the unit of re-coding is the frame coding mode, and notifies the re-coding unit 30 of the determination (step S107).

The re-coding unit 30 re-codes each picture received from the decoding unit 10. In that case, the re-coding unit 30 codes each macroblock to be inter-coded in accordance with the coding mode notified from the coding mode determination unit 20 (step S108). The re-coding unit 30 outputs the re-coded video data and ends the transcoding process.

As explained above, the video transcoder in this embodiment can re-code the video data, which has been coded in accordance with MBAFF scheme, in accordance with PAFF scheme. In that case, this video transcoder also applies the field coding mode in the re-coding to an area which includes large number of macroblocks which has been coded in accordance with the field coding mode, among the original coded video data. Thus, this video transcoder can appropriately select a mode having better coding efficiency among the field coding mode and the frame coding mode, without re-coding the decoded video data in both of the field coding mode and the frame coding mode respectively. By setting the unit of re-coding to the slice unit, if the moving object is shown only in the local area in the frame, this video transcoder can apply the field coding mode to the slice including the area in which the moving object is shown and apply the frame coding mode to other areas. Therefore, this video transcoder can improve the coding efficiency.

Next, the video transcoder according to a second embodiment will be explained. The video transcoder calculates, for every unit of re-coding in the coded video data, an accumulation value of generated information amount of the frame coded macroblock as a statistical value regarding a motion degree of the object shown is the frame coded macroblock. Similarly, the video transcoder calculates an accumulation value of the generated information amount of the field coded macroblock as a statistical value regarding a motion degree of the object shown in the field coded macroblock. Then, the video transcoder determines the coding mode to be applied when re-coding, based on a comparison result between the accumulation values of the generated information amount for respective coding modes.

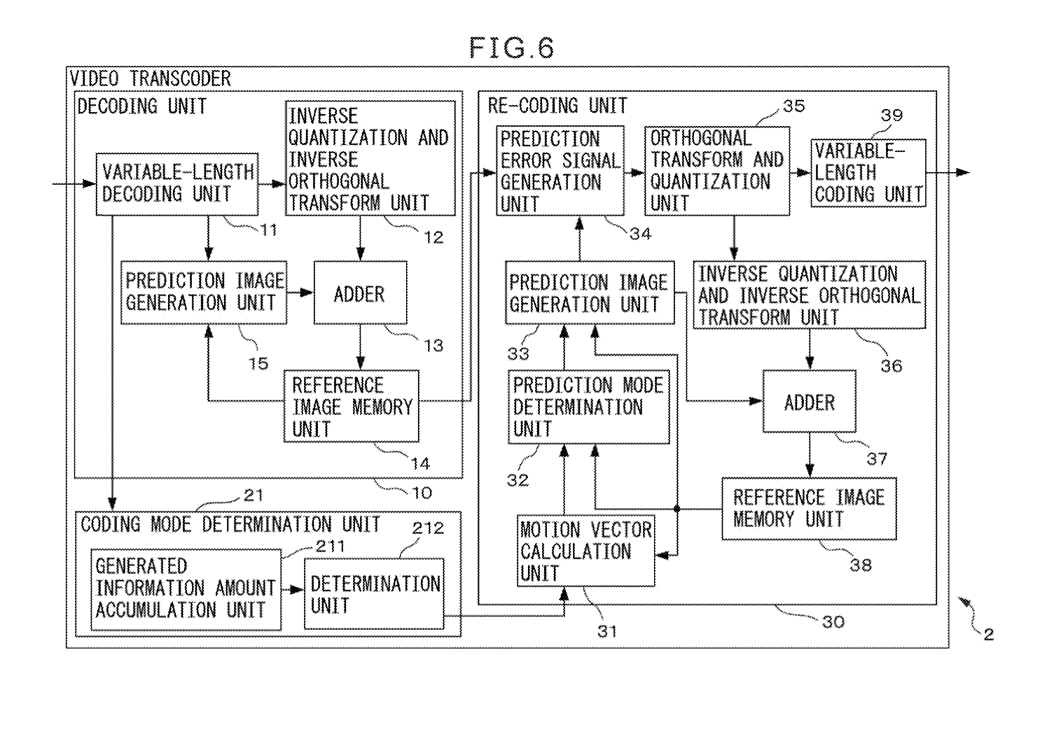

FIG. 6 is a schematic configuration diagram of a video transcoder 2 according to the second embodiment. The video transcoder 2 includes the decoding unit 10, a coding mode determination unit 21 and the decoding unit 30, as with the video transcoder 1 according to first embodiment. In FIG. 6, same reference number is given to each component of the video transcoder 2 as the reference number given to corresponding component in the video transcoder 1 illustrated in FIG. 1.

The video transcoder 2 differs in a process performed by the coding mode determination unit 21 in comparison with the video transcoder 1. Accordingly, hereinafter, description will be made for the coding mode determination unit 21 and matters relating to the coding mode determination unit 21, among the components of the video transcoder 2. It is noted that other components of the video transcoder 2 should refer to the description for the corresponding components of the video transcoder according to the first embodiment.

The variable-length decoding unit 11 of the decoding unit 10 performs the variable-length decoding to decode each inter-coded macroblock, and after that, notifies the coding mode determination unit 21 of the generated information amount of the macroblock with the coding mode applied to the macroblock. The generated information amount is represented by a total bit length of the bit sequence representing the quantized signal for the macroblock and the bit sequence representing the motion vector, for example.

The coding mode determination unit 21 includes a generated information amount accumulation unit 211 and a determination unit 212.

The generated information amount accumulation unit 211 accumulates the generated information amount of the macroblock coded in the frame coding mode and the generated information amount of the macroblock coded in the field coding mode respectively, for every unit of re-coding. The generated information amount accumulation unit 211 transfers the accumulated value FrameInfo of the generated information amount of the macroblock coded in the frame coding mode, and the accumulated value FieldInfo of the generated information amount of the macroblock coded in the field coding mode, each of which are calculated for the unit of re-coding, to the determination unit 212. The unit of re-coding complies with PAFF as with the first embodiment, and can be the slice unit, the picture unit, the GOP unit, or the reorder unit.

The determination unit 212 selects the coding mode to be applied when re-coding for every unit of re-coding, from among the frame coding mode and the field coding mode, based on the accumulated values of generated information amount FrameInfo and FieldInfo.

Referring to FIG. 4 again, the macroblocks in the area in which stationary object is shown and which is other than the area 410 in the frame 400 have a high correlativity with forward and backward frames in MBAFF scheme. Therefore, there is a high possibility that the frame coding mode is applied, and there is relatively little generated information amount. On the other hand, there is a high possibility that the field coding mode is applied to the macroblock included in the area 410 in which the moving object is shown in the frame 400. In particular, when many small moving objects are shown and these moving objects move in different ways, the generated information amount about the macroblock increases because of a low correlativity between the macroblock and the prediction image even if the field coding mode is applied. Similarly, as to the macroblock included in the area in which the object is shown, which deforms as time elapses, the generated information amount about the macroblock also increases because of a low correlativity between the macroblock and the prediction image. Thus, it is to be understood that the generated information amount for every macroblock relates to the motion degree of the object shown in the macroblock.

If it intends to inter-code the macroblock in which the moving object is shown in the frame coding mode, the correlativity between the macroblock and the prediction image further declines, thus the coding efficiency declines. Accordingly, in this embodiment, if the generated information amount of the macroblock coded in the field coding mode is larger, the determination unit 212 determines that the field coding mode is to be applied.

For example, the determination unit 212 determines that the coding mode to be applied to the unit of re-coding is the field coding mode, if the ratio (FieldInfo/FrameInfo) are equal to or more than predetermined threshold value Th2. On the contrary, if the ratio (FieldInfo/FrameInfo) is less than the threshold value Th2, the determination unit 212 determines that the coding mode to be applied to the unit of re-coding is the frame coding mode.

The threshold value Th2 can be set to 1, for example.

In this case, with respect to the original coded video data, when the generated information amount about the field coded macroblock is equal to or greater than the generated information amount about the frame coded macroblock, the field coding mode will be applied. Alternatively, in order to apply the field coding mode more easily than the frame coding mode, the threshold value Th2 may be set to a predetermined value less than 1, for example, to any of values more than 0.8 and less than 1.

The determination unit 212 notifies the re-coding unit 30 of the coding mode to be applied among the frame coding mode and the field coding mode, for every unit of re-coding.

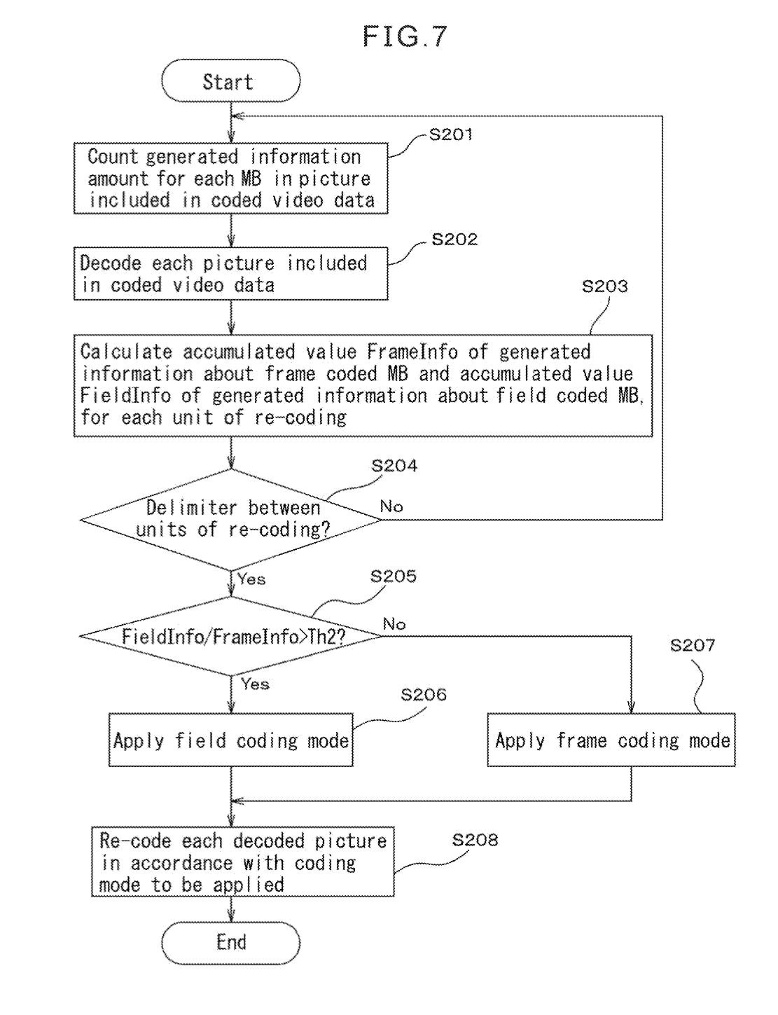

FIG. 7 is an operational flowchart of a video transcoding process performed by the video transcoder 2 according to the second embodiment.

The decoding unit 10 performs the variable-length decoding for each macroblock in the picture included in the coded video data to count the generated information amount for every macroblock (step S201). Then, the decoding unit 10 notifies the coding mode determination unit 21 of the generated information amount of the macroblock with information representing the coding mode for the macroblock. Moreover, the decoding unit 10 decodes each picture included in the coded video data (step S202). The decoding unit 10 outputs each decoded picture to the re-coding unit 30.

The generated information amount accumulation unit 211 of the coding mode determination unit 21 calculates the accumulated value FrameInfo of the generated information about the frame coded macroblock, and the accumulated value FieldInfo of the generated information about the field coded macroblock, for every unit of re-coding (step S203). The generated information amount accumulation unit 211 determines whether or not the notification of the delimiter between the units of re-coding has been received from the decoding unit 10 (step S204). If the generated information amount accumulation unit 211 has not received the notification of the delimiter between the units of re-coding (step S204—No), the video transcoder 2 repeats the processes from step S201.

On the other hand, if the generated information amount accumulation unit 211 has received the notification of the delimiter between the units of re-coding (step S204—Yes), the generated information amount accumulation unit 211 outputs each accumulated value to the determination unit 212 of the coding mode determination unit 21. The determination unit 212 determines whether or not the ratio (FieldInfo/FrameInfo) of the accumulated value FieldInfo of the generated information amount about the field coded macroblock to the accumulated value FrameInfo of the generated information amount about the frame coded macroblock is equal to or more than the threshold Th2 (step S205).

When the ratio (FieldInfo/FrameInfo) is equal to or more than the threshold Th2 (step S205—Yes), the determination unit 212 determines that the coding mode to be applied to the unit of re-coding is the field coding mode, and notifies the re-coding unit 30 of the determination (step S206). On the other hand, when the ratio (FieldInfo/FrameInfo) is less than the threshold Th2 (step S205—No), the determination unit 212 determines that the coding mode to be applied to the unit of re-coding is the frame coding mode, and notifies the re-coding unit 30 of the determination (step S207).

The re-coding unit 30 re-codes each picture received from the decoding unit 10. In that case, the re-coding unit 30 codes each macroblock to be inter-coded in accordance with the coding mode notified from the coding mode determination unit 21 (step S208). The re-coding unit 30 outputs the re-coded video data and ends the transcoding process.

As explained above, the video transcoder according to second embodiment applies the field coding mode when re-coding, if there is a large amount of generated information of the field coded macroblock in the coded video data which is input. Therefore, the field coding mode is applied to an area which includes more moving object shown in the video for example, and thus, it is possible to suppress a decline in the coding efficiency due to the re-coding in PAFF scheme.

Next, the video transcoder according to a third embodiment will be explained. The video transcoder calculates a statistical value representing a variation degree of the motion vectors of the macroblocks coded in the frame coding mode for every unit of re-coding in the original coded video data, as a statistical value regarding the frame coded macroblocks. Similarly, the video transcoder calculates a statistical value representing a variation degree of the motion vectors of the macroblocks coded in the field coding mode for every unit of re-coding, as a statistical value regarding the frame coded macroblocks. Then, the video transcoder determines the coding mode to be applied when re-coding, based on a comparison result between the statistical values representing variation degrees of the motion vectors for respective coding modes.

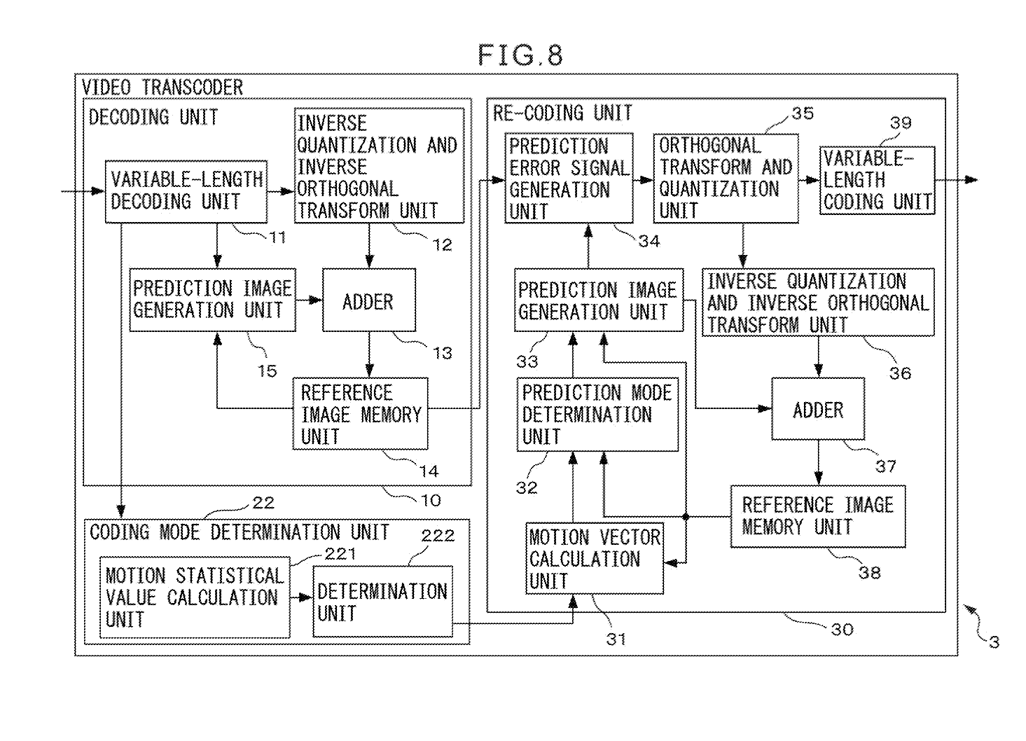

FIG. 8 is a schematic configuration diagram of a video transcoder 3 according to the third embodiment. The video transcoder 3 includes the decoding unit 10, a coding mode determination unit 22 and the decoding unit 30, as with the video transcoder 1 according to the first embodiment. In FIG. 8, same reference number is given to each component of the video transcoder 3 as the reference number given to corresponding component in the video transcoder 1 illustrated in FIG. 1.

The video transcoder 3 differs in a process performed by the coding mode determination unit 22 in comparison with the video transcoder 1. Accordingly, hereinafter, description will be made for the coding mode determination unit 22 and matters relating to the coding mode determination unit 22, among the components of the video transcoder 3. It is noted that other components of the video transcoder 3 should refer to the description for the corresponding components of the video transcoder according to the first embodiment.

The variable-length decoding unit 11 of the decoding unit 10 performs the variable-length decoding for the motion vector of each macroblock which is inter-coded, and after that, notifies the coding mode determination unit 22 of the motion vector with the coding mode applied to the macroblock.

The coding mode determination unit 22 includes a motion statistical value calculation unit 221 and a determination unit 222.

The motion statistical value calculation unit 221 calculates, for every unit of re-coding, the statistical value representing the variation degree of the motion vectors for macroblocks coded in the frame coding mode, and the statistical value representing the variation degree of the motion vectors for macroblocks coded in the field coding mode.

As described above, the area in which the stationary object is shown in the frame has high correlativity between continuous frames, therefore, applying the frame coding mode to such area leads to better coding efficiency. In this case, the motion vectors for respective macroblocks included in the area is nearly equal, therefore, the variation in the motion vectors is small. Moreover, even if the moving object is shown in the frame, correlativity between continuous frames is relatively high when the number of the shown moving object is small such as one or two and the moving object is rigid body. The variation in the motion vectors of respective macroblocks included in the frame is relatively small.

Referring to FIG. 4 again on the other hand, when many small moving objects are shown and these moving objects move in different ways, as illustrated by the area 410 in the frame 400, the direction and magnitude of the motion vector is also different in each macroblock and the variation in the motion vectors increases. Since such an area has low correlativity between the continuous frames, the number of the macroblocks which are coded in accordance with the field coding mode are more than the number of the macroblocks which are coded in accordance with the frame coding mode in MBAFF scheme. Similarly, when the object which deforms as time elapses is shown in a frame, there are large number of macroblocks which are coded in accordance with the field coding mode and the variation in motion vectors is large. Thus, since relevance is recognized between the variation degree of the motion vectors and the coding efficiency for every coding mode, the statistical value representing the variation degree of the motion vectors is useful information for determining coding mode.

The motion statistics value calculation unit 221 calculates a variance of the magnitude of motion vectors in accordance with the following equation as the statistical value representing the variation degree of the motion vectors.

$$VFieldMV = \frac{( {\sum }_{k = 1}^{FieldNum} {( {FieldMV}_{k} - AveFieldMV )}^{2} )}{FieldNum} \\ VFrameMV = \frac{( {\sum }_{j = 1}^{FrameNum} {( {FrameMV}_{j} - AveFrameMV )}^{2} )}{FrameNum} \qquad ( 2 )$$

Where, VFieldMV is a variance of the magnitude of motion vectors for the field coded macroblocks, and VFrameMV is a variance of the magnitude of motion vectors for the frame coded macroblocks. Moreover, AveFieldMV is an average value of the magnitude of the motion vectors for the field coded macroblocks, and AveFrameMV is an average value of the magnitude of the motion vectors for the frame coded macroblocks. FieldMVₖ (k=1, 2, . . . , FieldNum) and FrameMVⱼ (j=1, 2, . . . , FrameNum) represent the magnitude of the motion vectors of the field coded macroblocks and the magnitude of the motion vectors of the frame coded macroblocks, respectively. Moreover, FieldNum and FrameNum represent the total number of the field coded macroblocks and the total number of the frame coded macroblocks respectively, for every unit of re-coding. The unit of re-coding can be the slice unit, the picture unit, the GOP unit, or the reorder unit, as with the first embodiment.

The motion statistical value calculation unit 221 transfers VFrameMV and VFieldMV to the determination unit 222 for every unit of re-coding.

The motion statistical value calculation unit 221 may calculate, instead of the variance of the magnitude of motion vector, a variance of a horizontal component or a vertical component thereof, for each coding mode. Alternatively, the motion statistical value calculation unit 221 may calculate a variance of the direction of motion vector, for each coding mode. In this case, the direction of motion vector is defined by the angle between the motion vector and a horizontal direction of the frame, for example. Moreover, the motion statistical value calculation unit 221 may calculate an inter-quartile range of the magnitude of motion vector, instead of the variance of the magnitude of motion vector, for each coding mode.

The determination unit 222 selects the coding mode to be applied when re-coding for every unit of re-coding, from among the frame coding mode and the field coding mode, based on the variance of motion vectors VFrameMV and VFieldMV.

For example, the determination unit 222 determines that the coding mode to be applied to the unit of re-coding is the field coding mode, if a ratio (VFieldMV/VFrameMV) is equal to or more than a predetermined threshold value Th3. On the contrary, if the ratio (VFieldMV/VFrameMV) is less than the threshold value Th3, the determination unit 222 determines that the coding mode to be applied to the unit of re-coding is the frame coding mode.

The threshold value Th3 is set to 1, for example. In this case, when the variation degree of the motion vectors for the field coded macroblocks is equal to or more than the variation degree of the motion vectors for the frame coded macroblocks in the original coded video data, the field coding mode will be applied. Alternatively, in order to apply the field coding mode more easily than the frame coding mode, the threshold value Th3 may be set to a predetermined value less than 1, for example, to any of values more than 0.8 and less than 1.

The determination unit 222 notifies the re-coding unit 30 of the coding mode to be applied among the frame coding mode and the field coding mode, for every unit of re-coding.

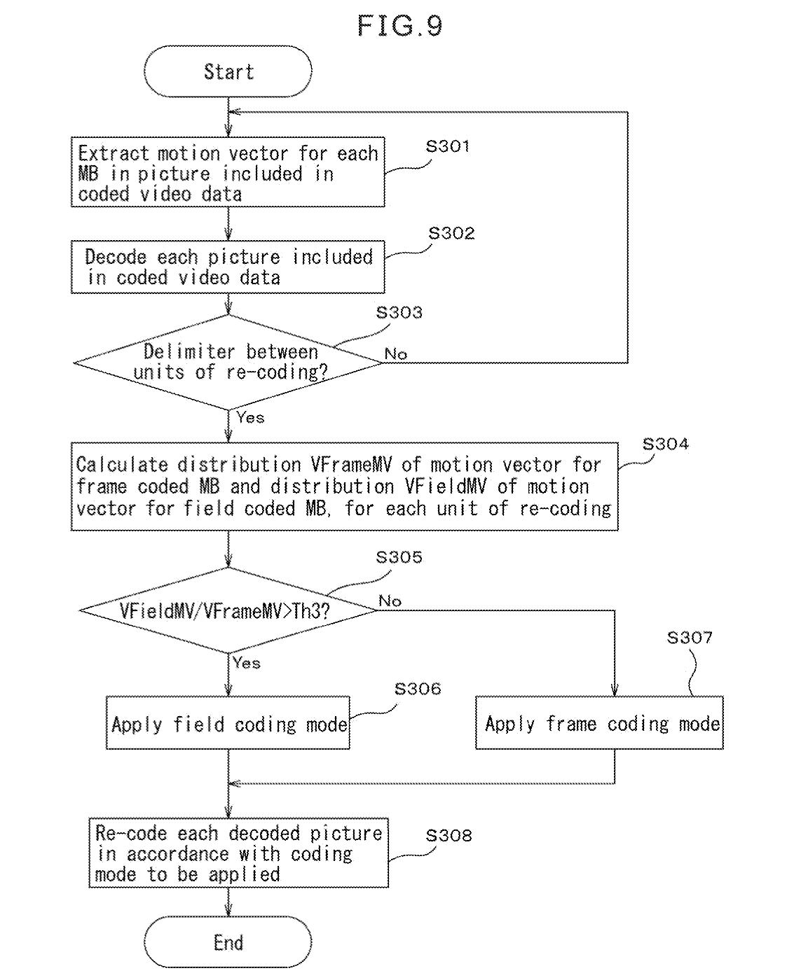

FIG. 9 is an operational flowchart of a video transcoding process performed by the video transcoder 3 according to the third embodiment.

The decoding unit 10 performs the variable-length decoding for the motion vector of each macroblock in the picture included in the coded video data (step S301). The decoding unit 10 notifies the coding mode determination unit 22 of the motion vector of the macroblock with the information representing the coding mode of the macroblock. Moreover, the decoding unit 10 decodes each picture included in the coded video data (step S302). Then, the decoding unit 10 outputs each decoded picture to the re-coding unit 30.

The motion statistical value calculation unit 221 of the coding mode determination unit 22 determines whether or not the notification of the delimiter between the units of re-coding has been received (step S303). If the motion statistical value calculation unit 221 has not received the notification of the delimiter between the units of re-coding (step S303—No), the video transcoder 3 repeats the processes from the step S301.

On the other hand, if the motion statistical value calculation unit 221 has received the notification of the delimiter between the units of re-coding (step S303—Yes), the motion statistical value calculation unit 221 calculates the variance VFrameMV of the motion vectors for the frame coded macroblocks, and the variance VFieldMV of the motion vectors for the field coded macroblocks, for every unit of re-coding (step S304). The determination unit 222 of the coding mode determination unit 21 determines whether or not the ratio (VFieldMV/VFrameMV) of the variance VFieldMV of the motion vectors for the field coded macroblocks to the variance VFrameMV of the motion vectors for the frame coded macroblocks is equal to or more of the predetermined threshold value Th3 (step S305).

When the ratio (VFieldMV/VFrameMV) is equal to or more than the threshold value Th3 (step S305—Yes), the determination unit 222 determines that the coding mode to be applied to the unit of re-coding is the field coding mode, and notifies the re-coding unit 30 of the determination (step S306). On the other hand, when the ratio (VFieldMV/VFrameMV) is less than the threshold value Th3 (step S305—No), the determination unit 222 determines that the coding mode to be applied to the unit of re-coding is the frame coding mode, and notifies the re-coding unit 30 of the determination (step S307).

The re-coding unit 30 re-codes each picture received from the decoding unit 10. In that case, the re-coding unit 30 codes each macroblock to be inter-coded in accordance with the coding mode notified from the coding mode determination unit 22 (step S308). Then, the re-coding unit 30 outputs the re-coded video data, and ends the transcoding process.

As explained above, the video transcoder according to the third embodiment applies the field coding mode when re-coding, if the variance of motion vectors for the field coded macroblocks is relatively large in the coded video data which is input. Therefore, the field coding mode is applied to an area which includes more moving object shown in the video for example, and thus, it is possible to suppress a decline in the coding efficiency due to the re-coding in PAFF scheme.

According to a modification, the coding mode determination unit may determine the coding mode to be applied when re-coding by combining two or all three of criterion for determination in each of above-mentioned embodiments. For example, the coding mode determination unit may adjust the threshold value Th1 to the ratio (FieldNum/Total) regarding the number of the field coded macroblocks in accordance with the comparison result between the ratio (VFieldMV/VFrameMV) regarding the variance of motion vector and the threshold value Th3. For example, if the ratio (VFieldMV/VFrameMV) regarding the variance of motion vectors is less than the threshold value Th3, the threshold value Th1 may be set to 0.5, and on the other hand, if the ratio (VFieldMV/VFrameMV) is equal to or more than the threshold value Th3, the threshold value Th1 is set any value less than 0.5. Furthermore, the threshold value Th1 may be determined so that it becomes small as the ratio (VFieldMV/VFrameMV) becomes large. In this modification, the coding mode determination unit determines that the field coding mode is to be applied if the ratio (FieldNum/Total) is equal to or more than the adjusted threshold value Th1, otherwise, the coding mode determination unit determines that the frame coding mode is to be applied.

Similarly, the coding mode determination unit may set the threshold value Th2 to the ratio (FieldInfo/FrameInfo) regarding the generated information amount to smaller value, as the ratio (VFieldMV/VFrameMV) regarding the variance of motion vector becomes larger. Then, the coding mode determination unit may determine that the field coding mode is to be applied, if the ratio (FieldInfo/FrameInfo) regarding the generated information amount is equal to more than the threshold value Th2. Alternatively, the coding mode determination unit may set the threshold value Th1 to the ratio (FieldNum/Total) regarding the number of the field coded macroblocks to smaller value, as the ratio (FieldInfo/FrameInfo) regarding the generated information amount becomes larger. Then, the coding mode determination unit may determine that the field coding mode is to be applied, if the ratio (FieldNum/Total) regarding the number of the field coded macroblocks is equal to more than the threshold value Th1.

Furthermore, if the ratio (VFieldMV/VFrameMV) regarding the variance of motion vectors is equal to or more than the threshold value Th3 and the ratio (FieldInfo/FrameInfo) regarding the generated information amount is equal to or more than the threshold value Th2, the coding determination unit may set the threshold value Th1 to a value less than 0.5, for example, 0.4. On the other hand, if the ratio (VFieldMV/VFrameMV) is less than the threshold value Th3 or the ratio (FieldInfo/FrameInfo) is less than the threshold value Th2, the coding determination unit may set the threshold value Th1 to 0.5.

Moreover, according to another modification, as for the coded video data which is input into the video transcoder, the field coding mode and the frame coding mode may be switched in the slice unit. Also in this case, the video transcoder, when re-coding, may select the coding mode to be applied among the field coding mode and the frame coding mode in the unit of re-coding which is larger than the slice unit, for example, in the picture unit or the GOP unit.

The computer program, which can realize the functions of respective units in the video transcoder according to each of embodiments and the modifications on a processor, may be provided in the form of being recorded on medium which can be read by a computer.

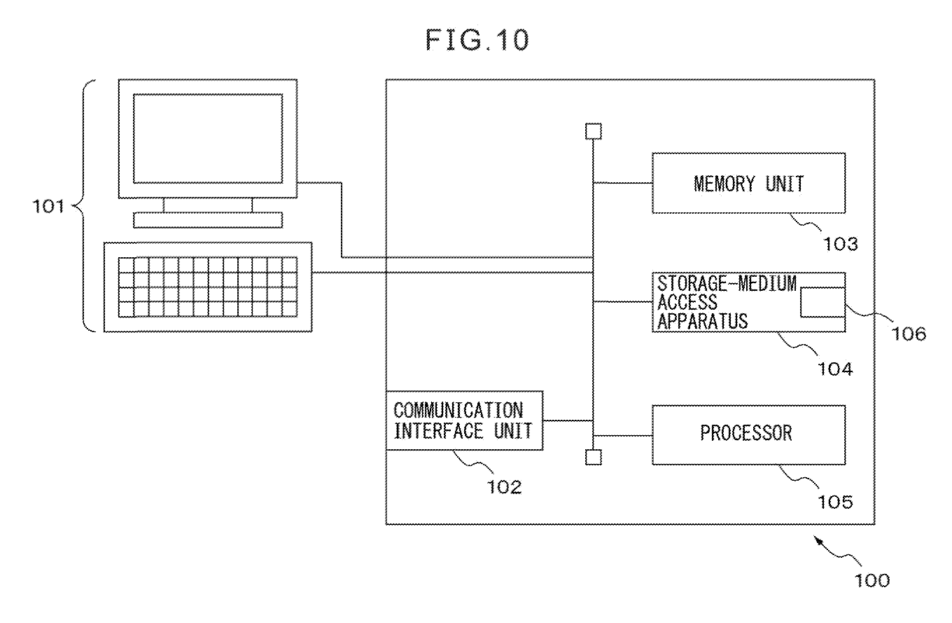

FIG. 10 is a schematic diagram of a computer which operates as the video transcoder by executing the computer program to realize the function of each unit in the video transcoder according to each of above-described embodiments and the modifications.

The computer 100 includes a user interface unit 101, a communication interface unit 102, a memory unit 103, a storage-medium access apparatus 104, and a processor 105. The processor 105 is connected with the user interface unit 101, the communication interface unit 102, the memory unit 103, and the storage-medium access apparatus 104 through a bus, for example.

The user interface unit 101 includes an input device such as a keyboard and a mouse, and a display device such as a liquid crystal display, for example. Alternatively, the user interface unit 101 may include a device in which the input device and the display device are integrated, such as a touch panel display. The user interface unit 101 outputs an operation signal, which makes the video transcoding process start, to the processor 105 in accordance with an operation by the user, such that the coded video data which is displayed on the display device is selected.

The communication interface unit 102 may include a communication interface for connecting the computer 100 with a video input device (not illustrated) such as a video camera, and a control circuit. Such a communication interface can be Universal Serial Bus (USB), for example.

The communication interface unit 102 may include a communication interface for connecting to a communication network which complies with the telecommunication standards such as Ethernet (registered trademark), and a control circuit.

In this case, the communication interface unit 102 acquires a data stream including the coded video data from other equipment connected to an image reader or the communication network, and transfers the data stream to the processor 105.

Moreover, the communication interface unit 102 may output the re-coded video data which is received from the processor 105 to other equipment through the communication network.

The memory unit 103 includes a semiconductor memory which is readable and writable, and a read-only semiconductor memory, for example. The memory unit 103 stores a computer program executed by the processor 105 to perform the video transcoding process, the coded video data, or the video data re-coded by the processor 105.

The storage-medium access apparatus 104 is, for example, an apparatus which accesses the storage media 106, such as a magnetic disk, a semiconductor memory card and an optical storage medium. The storage-medium access apparatus 104 reads, for example, the computer program for the video transcoding process, which is executed by the processor 105 and is stored in the storage medium 106, and transfers the program to the processor 105. Moreover, the storage-medium access apparatus 104 may write the video data re-coded by the processor 105 in the storage medium 106.

The processor 105 re-codes the coded video data by executing the computer program for video transcoding process according to any of above-described embodiments and modifications. Then, the processor 105 stores the re-coded video data in the memory unit 103, or outputs the data to other equipment through the communication interface unit 102.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various change, substitutions, and alterations could be made hereto without departing from the spirit and scope of the invention.

What is claimed is:

1. A video transcoder that re-codes each of a plurality of blocks which are divided from a frame included in coded video data which has been coded for each first unit of coding by switching a frame coding mode for coding the blocks on the basis of a frame and a field coding mode for coding the blocks on the basis of a field, in accordance with any of the frame coding mode and the field coding mode for each second unit of coding the video transcoder comprising:
a decoding unit which decodes the coded video data;
a coding mode determination unit which calculates a first statistical value regarding the number of frame coded blocks or a degree of motion of an object shown in the frame coded blocks, and a second statistical value regarding the number of field coded blocks or a degree of motion of the object shown in the field coded blocks for each second unit of coding of the coded video data, the second unit of coding being larger than the first unit of coding, and compares the first statistical value and the second statistical value to determine a coding mode to be applied among the frame coding mode and the field coding mode for each second unit of coding; and
a re-coding unit which re-codes a block which belongs to a first frame and is coded with reference to a second frame, which is different from the first frame, among a plurality of blocks within the second unit of coding, in the coding mode which is determined to be applied among the frame coding mode and the field coding mode, for each second unit of coding.

2. The video transcoder according to claim 1, wherein
the coded video data includes coding mode information representing whether the block is field-coded or frame-coded for each block,
the decoding unit extracts the coding mode information from the coded video data, and
the coding mode determination unit calculates the number of the frame coded blocks as the first statistical value and the number of the field coded blocks as the second statistical value for each second unit of coding based on extracted coding mode information, and determines that the coding mode to be applied is the field coding mode when a ratio of the number of the field coded blocks to a sum of the number of the frame coded blocks and the number of the field coded blocks is equal to or more than a predetermined threshold value.

3. The video transcoder according to claim 1, wherein
the decoding unit calculates a generated information amount for each of the frame coded blocks and a generated information amount for each of the field coded blocks from the coded video data, and
the coding mode determination unit calculates an accumulation value of the generated information amount for the frame coded blocks as the first statistical value and an accumulation value of the generated information amount for the field coded blocks as the second statistical value for each second unit of coding, and determines that the coding mode to be applied is the field coding mode when a ratio of the second statistical value to the first statistical value is equal to or more than a predetermined threshold value.

4. The video transcoder according to claim 1, wherein
the decoding unit extracts motion vectors for each of the frame coded blocks and motion vectors for each of the field coded blocks from the coded video data, and
the coding mode determination unit calculates, for each second unit of coding, a statistical value representing variation degree of the motion vectors regarding the frame coded blocks as the first statistical value, calculates a statistical value representing variation degree of the motion vectors regarding the field coded blocks as the second statistical value, and determines that the coding mode to be applied is the field coding mode when a ratio of the second statistical value to the first statistical value is equal to or more than a predetermined threshold value.

5. A video transcoding method for re-coding each of a plurality of blocks which are divided from a frame included in coded video data which has been coded for each first unit of coding by switching a frame coding mode for coding the blocks on the basis of a frame and a field coding mode for coding the blocks on the basis of a field, in accordance with any of the frame coding mode and the field coding mode for each second unit of coding, the method comprising:
decoding the coded video data by a processor;
calculating, by the processor, a first statistical value regarding the number of frame coded blocks or a degree of motion of an object shown in the frame coded blocks, and a second statistical value regarding the number of field coded blocks or a degree of motion of the object shown in the field coded blocks for each second unit of coding of the coded video data, the second unit of coding being larger than the first unit of coding, and comparing the first statistical value and the second statistical value to determine a coding mode to be applied among the frame coding mode and the field coding mode for each second unit of coding; and
re-coding, by the processor, a block which belongs to a first frame and is coded with reference to a second frame, which is different from the first frame, among a plurality of blocks within the second unit of coding, in the coding mode which is determined to be applied among the frame coding mode and the field coding mode, for each second unit of coding.

6. The video transcoding method according to claim 5, wherein
the coded video data includes coding mode information representing whether the block is field-coded or frame-coded for each block,
the decoding the coded video data includes extracting the coding mode information from the coded video data, and
determining the coding mode includes calculating the number of the frame coded blocks as the first statistical value and the number of the field coded blocks as the second statistical value for each second unit of coding based on extracted coding mode information, and determining that the coding mode to be applied is the field coding mode when a ratio of the number of the field coded blocks to a sum of the number of the frame coded blocks and the number of the field coded blocks is equal to or more than a predetermined threshold value.

7. The video transcoding method according to claim 5, wherein
the decoding the coded video data includes calculating a generated information amount for each of the frame coded blocks and a generated information amount for each of the field coded blocks from the coded video data, and
determining the coding mode includes calculating an accumulation value of the generated information amount for the frame coded blocks as the first statistical value and an accumulation value of the generated information amount for the field coded blocks as the second statistical value for each second unit of coding, and determining that the coding mode to be applied is the field coding mode when a ratio of the second statistical value to the first statistical value is equal to or more than a predetermined threshold value.

8. The video transcoding method according to claim 5, wherein
the decoding the coded video data includes extracting motion vectors for each of the frame coded blocks and motion vectors for each of the field coded blocks from the coded video data, and
determining the coding mode includes calculating, for each second unit of coding, a statistical value representing variation degree of the motion vectors regarding the frame coded blocks as the first statistical value, calculating a statistical value representing variation degree of the motion vectors regarding the field coded blocks as the second statistical value, and determining that the coding mode to be applied is the field coding mode when a ratio of the second statistical value to the first statistical value is equal to or more than a predetermined threshold value.

9. A computer-readable recording medium having stored therein a program for causing a computer to execute a process which re-code each of a plurality of blocks which are divided from a frame included in coded video data which has been coded for each first unit of coding by switching a frame coding mode for coding the blocks on the basis of a frame and a field coding mode for coding the blocks on the basis of a field, in accordance with any of the frame coding mode and the field coding mode for each second unit of coding, the process comprising:
decoding the coded video data;
calculating a first statistical value regarding the number of frame coded blocks or a degree of motion of an object shown in the frame coded blocks, and a second statistical value regarding the number of field coded blocks or a degree of motion of the object shown in the field coded blocks for each second unit of coding of the coded video data, the second unit of coding being larger than the first unit of coding, and comparing the first statistical value and the second statistical value to determine a coding mode to be applied among the frame coding mode and the field coding mode for each second unit of coding; and
re-coding a block which belongs to a first frame and is coded with reference to a second frame, which is different from the first frame, among a plurality of blocks within the second unit of coding, in the coding mode which is determined to be applied among the frame coding mode and the field coding mode, for each second unit of coding.

10. A video transcoder that re-codes each of a plurality of blocks which are divided from a frame included in coded video data which has been coded for each first unit of coding by switching a frame coding mode for coding the blocks on the basis of a frame and a field coding mode for coding the blocks on the basis of a field, in accordance with any of the frame coding mode and the field coding mode for each second unit of coding, the video transcoder comprising:
a processor configured to
decode the coded video data;
calculate a first statistical value regarding the number of frame coded blocks or a degree of motion of an object shown in the frame coded blocks, and a second statistical value regarding the number of field coded blocks or a degree of motion of the object shown in the field coded blocks for each second unit of coding of the coded video data, the second unit of coding being larger than the first unit of coding, and compare the first statistical value and the second statistical value to determine a coding mode to be applied among the frame coding mode and the field coding mode for each second unit of coding; and
re-code a block which belongs to a first frame and is coded with reference to a second frame, which is different from the first frame, among a plurality of blocks within the second unit of coding, in the coding mode which is determined to be applied among the frame coding mode and the field coding mode, for each second unit of coding.
